(19) United States
(12) Patent Application Publication
(10) Pub. No.: US 2023/0299312 A1
(43) Pub. Date: Sep. 21, 2023

(54) TEMPERATURE-CONTROL DEVICE FOR A STACK-LIKE ENERGY STORE OR CONVERTER, AND A FUEL CELL STACK HAVING A TEMPERATURE-CONTROL DEVICE OF SAID TYPE

(71) Applicant: Siqens GmbH, Munich (DE)

(72) Inventors: Felix HENNERSPERGER, Munich (DE); Volker HARBUSCH, Munich (DE); Matthias WOESSNER, Munich (DE)

(21) Appl. No.: 18/041,562

(22) PCT Filed: Aug. 6, 2021
(86) PCT No.: PCT/EP2021/072090

§ 371 Date: Feb. 14, 2023

(30) Foreign Application Priority Data
Aug. 14, 2020 (DE) 10 2020 121 461.8

(51) Int. Cl. H01M 8/04007; H01M 8/04014; H01M 8/0258

(52) U.S. Cl. CPC H01M 8/04074; H01M 8/04014; H01M 8/0258

(57) ABSTRACT

The present invention relates to a tempering device for tempering of a stacked energy storage device or energy converter comprising a plurality of cells and comprising a plurality of plate-shaped heat conduction elements arranged between the cells, the tempering of the cells being effected via the plate-shaped heat conduction elements by means of heat conduction,
a plurality of tempering ribs arranged outside the cells for changing the flow direction of the tempering air stream, the tempering ribs being thermally coupled to the heat conduction elements, and the tempering of the plate-shaped tempering ribs being effected by exposure to a tempering air stream by means of convection and/or via further means by means of heat conduction, the means for influencing the tempering air flow and/or for guiding the tempering air, which are designed to change a flow direction and/or a flow velocity of the tempering air flow, the means being structurally designed and/or arranged in such a way that several of the tempering ribs can be acted upon by a tempering air volume flow in such a way that a majority of the cells in a cell center can be heated or cooled approximately uniformly, and wherein the means for influencing the tempering air flow and/or for tempering air guidance comprise one and preferably two or more of the following components

at least one further tempering rib, the shape and/or arrangement of which differs from the shape and/or arrangement of the other tempering ribs, and/or

at least one resistor element to change the tempering air flow by local distribution of pressure drops and/or by vortex formation, and/or

at least one tempering air guiding element for further changing the flow direction and/or the flow velocity of the tempering air flow compared to changing the flow direction and/or the flow velocity of the tempering air flow by the tempering ribs and/or at least one tempering body, which is designed as a heat exchanger.

The present invention relates to a tempering device for a fuel cell stack and to a fuel cell stack comprising such a tempering device.

A fuel cell is a device for generating electrical energy by the reaction of fuel (e.g. hydrogen, propane, natural gas, methanol) and oxygen. In its simplest design, such a cell essentially consists of supply plates with channels for fuel/hydrogen supply (anode) and supply plates for air/oxygen supply (cathode), these plates being separated and sealed from each other by an ion-conducting membrane or layer. For example, hydrogen can be supplied directly to the cell as a fuel, or it can be produced by conversion from another fuel, such as methane, methanol, propane, or another eligible hydrocarbon, ether, or alcohol. In practice, to increase power, several units consisting of anode and cathode, called cells, are connected in series to form a fuel cell stack. The classification of the different types of fuel cells is based on the one hand on the electrolyte (e.g. polymer electrolyte membrane fuel cell, PEMFC) and on the other hand on the fuel used (e.g. direct methanol fuel cell, DMFC).

In order for a fuel cell stack to reach its operating temperature, it must be heated by means of a heating device (for example, electric heater, heating medium or burner) when a corresponding fuel cell system is started.

EP 1 703 578 A1 discloses a gas-powered starting system for a reformer fuel cell system. This comprises at least a reformer, a fuel cell and a burner arranged outside the fuel cell, such as a low flame height surface burner, e.g. a burner with a ceramic or metallic surface or a surface made of fiber materials, such as a ceramic fiber mat coated with silicon carbide, to heat the reformer and fuel cell stack.

DE 199 10 387 A1 describes a fuel cell battery with a stack and a heating device. The heat provided by the heating device is to be usable for heating the fuel cell stack. The heating device preferably comprises a heating element such as a catalytic burner and/or an electric heating element and/or a reformer device.

During operation, however, a fuel cell stack must be cooled. Otherwise, due to the exothermic reaction taking place inside, it would heat up to such an extent that the fuel cell stack would rapidly degrade.

DE 199 31 061 A discloses a fuel cell system with a cooling circuit. A heat sink is connected to a supply line for the fuel and/or oxidant in such a way that a corresponding heat exchange can take place. Thus, it should be possible to heat the gas/fluid streams of the fuel cell with the waste heat of a cooling system.

An embodiment of an HTPEM fuel cell with liquid cooling is described in DE 10 2007 044 634 B4.

EP 1 498 967 A2 describes a PEMFC in which cooling air is guided through cooling plates integrated in a fuel cell stack, with cooling channels open to the outside. U.S. Pat. No. 2,011,013 60 30 A1 describes cooling fins for a HT PEMFC, which are designed as an extension of a supply plate. WO 2011 154 084 A2 discloses a fuel cell stack with cooling fins, additional cooling channels being provided in these fins as a substructure. US 809 73 85 B2 discloses a combination of thermally conductive material and cooling fins to cool a fuel cell stack. US 049 388 33 A discloses an arrangement in which a fuel cell stack is formed of cooling and supply plates made of metal. A layer of thermally conductive grafoil is interposed between these plates. US 680 88 34 B2 discloses a fuel cell stack for a polymer electrolyte fuel cell. To improve cooling, this has cooling fins on one long side, which consist of a sheet of expanded graphite projecting beyond the fuel cell stack toward the long side. US 592 88 07 A describes a supply plate for a PEM fuel cell with an integrated seal. The plate itself is made of a plastically deformable material, for example graphite foil, into which the channels are pressed. The sealing effect is created by an elevation on this material, which is compressed during assembly.

In the case of fuel cell stacks, there is often the challenge of achieving a uniform temperature distribution over the fuel cell stack, since the heat generated during operation must be dissipated uniformly. At present, this is often achieved by means of an additional oil or water cooling system integrated into the fuel cell stack, which is, however, error-prone, complex and expensive. Furthermore, cooling plates are required in the fuel cell stack, which represent an additional weight and cost factor and often also have to be specially sealed. These variants are also difficult to reconcile economically with internal reforming in the fuel cell stack in separate chambers, since separate reformer chambers with separate supplies would be required in addition to the cooling plates. Flowing cooling air through the fuel cell stack, as is sometimes done, is also associated with disadvantages such as large space requirements due to cooling channels integrated in the fuel cell stack, increased weight, poor compatibility in terms of cost and space with internal reforming in the stack, a high temperature difference within the individual cells depending on the design or complexity (influence on performance or degradation), and increased fan power requirements due to increased pressure loss due to the flow through the internal channels.

The object of the present invention is to provide an efficient device for tempering, i.e. for heating and cooling, of a fuel cell stack, which is simple and inexpensive in design and safe and reliable in operation.

A further task is to provide a device for tempering of a fuel cell stack which enables the temperature to be distributed as homogeneously as possible over the individual cells of a fuel cell stack.

This task is solved with a device according to claim 1. Advantageous embodiments thereof are indicated in the subclaims.

The present invention relates to a tempering device for controlling the temperature of a stack-type energy storage device or converter formed of a plurality of cells comprising a plurality of plate-shaped heat conduction elements arranged between the cells, the tempering of the cells being effected via the plate-shaped heat conduction elements by means of heat conduction,

a plurality of tempering ribs arranged outside the cells for changing the flow direction of the tempering air stream, the tempering ribs being thermally coupled to the heat conduction elements, and the tempering of the plate-shaped tempering ribs being effected by exposure to a tempering air stream by means of convection and/or via further means by means of heat conduction,

the means for influencing the tempering air flow and/or for tempering air guidance, which are designed to change a flow direction and/or a flow velocity of the tempering air flow, the means being structurally designed and/or arranged in such a way that several of the tempering ribs can be acted upon by a tempering air volume flow in such a way that a majority of the cells in a cell center can be heated or cooled approximately uniformly, and wherein the means for influencing the tempering air flow and/or for tempering air guidance comprise one and preferably two or more of the following components

at least one further tempering rib, the shape and/or arrangement of which differs from the shape and/or arrangement of the other tempering ribs, and/or

at least one resistor element to change the tempering air flow by local distribution of pressure drops and/or by vortex formation, and/or

at least one tempering air guiding element for further changing the flow direction and/or the flow velocity of the tempering air flow compared to changing the flow direction and/or the flow velocity of the tempering air flow through the tempering ribs and/or

at least one tempering body, which is designed as a heat exchanger.

In the context of the present invention, a stack-type energy storage device or converter is understood to be a fuel cell, in particular a fuel cell stack, an electrolyzer or a redox flow battery.

In the context of the present invention, the term “tempering” is understood to mean heating or cooling the stack-type energy storage device or energy converter in order to operate it more efficiently and/or to achieve a predetermined operating condition more quickly.

The temperature of the cells is controlled via the plate-shaped heat conduction elements arranged between the cells inside the stack-type energy storage unit by means of heat conduction.

This ensures uniform and efficient temperature control. In most cases, such devices are provided only on outer walls of devices to be tempered. Such an arrangement does not allow uniform tempering, since a corresponding device can only be tempered from the outside to the inside. In addition, foils are known as heat conduction elements, which are arranged between individual cells. However, due to their low thickness, these also do not allow efficient temperature control. The use of expensive high-performance materials that are difficult to process, such as pyrolytic graphite, is not economical for many applications.

The invention is characterized by providing the plurality of plate-like heat conduction elements disposed between the cells.

The heat conduction elements may have a thickness greater than 0.9 mm or 1 mm or 1.2 mm and preferably greater than 1.4 mm. For example, the thickness may be 2.0 mm or 3.0 mm. The greater the thickness, the better the temperature distribution. However, a greater thickness results in a greater length of the cell stack, which is disadvantageous in terms of installation space. For most applications, a maximum thickness of 3.5 mm or 3.75 mm or 4.0 mm seems reasonable.

Due to their thickness, the heat conduction elements have a higher and more efficient thermal conductivity compared to foils.

In addition, the present invention is characterized in that the plurality of tempering ribs arranged outside the cells are provided, wherein the tempering of the plate-shaped tempering ribs is performed by applying a tempering air flow in a tempering direction by means of convection and/or via further means by means of heat conduction, and wherein the tempering ribs are thermally coupled to the heat conduction elements.

In the context of the present invention, a first cell of a stack-type energy storage device, such as a fuel cell stack, may be referred to as an initial cell and a final cell may be referred to as an end cell.

The tempering direction is preferably a main flow direction of the tempering air flow or a tempering air volume flow. The tempering direction may be directed from an initial cell to an end cell, approximately parallel to one or more sidewalls of the fuel cell stack and in a main flow direction of the tempering air provided by a blower device.

The tempering air flow or the tempering direction is influenced, among other things, by structural conditions, for example lack of space in a dimension orthogonal to a surface of a component to be cooled, for example a fuel cell stack. The fuel cell stack including the tempering device can thus be suitably integrated into a fuel cell system with, for example, a low height in one dimension while at the same time utilizing the advantages of the cooling method. Accordingly, the tempering device is very compact due to the combination and structural design of the means for influencing the tempering air flow.

If the tempering ribs are not only thermally coupled to the heat conduction elements but also mechanically connected to them, they are referred to below as tempering elements.

If, for example, a fuel cell stack with plates of the same design and projecting from the stack were to be subjected to a tempering air flow, this would lead to a very uneven distribution of the air mass flow or air volume flow and thus to uneven tempering of the fuel cell stack. Among other things, according to the conservation of momentum or inertia of the gas particles, a large part of the air volume flow would flow at the rear plates protruding from the fuel cell stack, while a small air volume flow would flow at the front protruding plates. As a result, the temperature distribution of the fuel cell stack would be uneven and would not be sufficient to achieve the longest possible lifetime of the fuel cell stack at a predetermined set temperature.

If, on the other hand, a tempering air guide according to the invention is provided, e.g. by means of the tempering channel, the distribution of the air mass flow or air volume flow is approximately uniform and a uniform temperature distribution is achieved in the fuel cell stack. The service life is then significantly higher (up to 40 percent) as is the performance of the fuel cell stack (up to 5 percent). In addition, the fan power of a blower unit to achieve the same stack average temperature would be lower (by up to 15 percent).

Since fuel cell systems are generally more expensive to purchase than diesel generators, for example, a long service life is important from a market perspective in order to achieve low total cost of ownership.

The service life of the cells is influenced by the operating temperature, among other factors. In high-temperature polymer electrolyte fuel cells (HT-PEM fuel cells), for example, more phosphoric acid evaporates at higher temperatures. For example, cells operated 10 degrees Celsius warmer would degrade much faster than cells operated 10 degrees Celsius colder. Since fuel cells continue to degrade disproportionately quickly after degradation has already occurred due to low potential, among other reasons, one or more worst cells limit the lifetime of the entire fuel cell stack.

The performance of the fuel cell stack is also affected by the temperature distribution. For example, colder cells of the HT-PEM fuel cell stack would have disproportionately poorer performance due to lower phosphoric acid proton conductivity at (e.g., 10 degrees Celsius) lower temperatures. Also, their sensitivity to components/impurities in the anode gas that are negative for performance, such as carbon monoxide, is increased.

A good temperature distribution during operation thus significantly benefits the service life of the fuel cell stack, among other things, as well as its power.

For the heating process, the temperature distribution is decisive, for example in the case of HT-PEM fuel cells, because the fuel cell stack may only be operated when a certain minimum temperature (for example 105 degrees Celsius) has been reached, so that water can evaporate in order not to expel any phosphoric acid droplets from the fuel cell or so that product water formed by the fuel cell reaction immediately passes into the gas phase and the phosphoric acid is not diluted by water and its volume increases, which can lead to its discharge and would result in degradation of the fuel cell. Since the heating process must be as short as possible to meet market requirements, it is advantageous to have the temperature of the fuel cell stack as uniform as possible during heating. The energy required for the heating process is also lower with a uniform distribution, which would mean, for example, lower consumption of fuel when obtaining the heat from a combustion process or lower consumption of electrical energy from an accumulator.

The invention can be used on fuel cell stacks as well as on galvanic elements, primary cells, batteries, secondary cells, accumulators, redox flow batteries, electrolyzers as well as on similar assemblies/components such as microreactors, reactors, heat exchangers, mixers and burners with stacked reaction spaces (cells) and on similar setups with layered or stacked functional spaces/components (cells). The cells thus represent, among other things, cells in the sense of fuel cell, electrolyzer, accumulator or battery technology or functional units or spaces that fulfill one or more function(s). The individual cells may be closed or open systems. Such devices are referred to in the context of the present invention as stacked energy storage devices or energy converters.

The cells may contain electrolyte membranes, polymer electrolytes, electrolyte films, electrolyte layers or electrolyte plates and/or, for example, solid electrolytes or liquid electrolytes. Furthermore, the cells may contain catalysts or catalytically active materials. The cells may be formed or constructed from electrically conductive and/or non-electrically conductive components.

In the following, advantageous embodiments of the present invention are explained with reference to a fuel cell stack. In the case of a fuel cell stack, for example, the membrane electrode assemblies or the combination of membrane electrode assemblies with associated sealing elements as well as associated electrically conductive plates (for example bipolar plates) and/or possibly other associated components can form the cells.

The plurality of tempering ribs assigned to a side wall of the device can have surfaces of at least partially different sizes and/or surfaces of at least partially the same size and/or in that the tempering ribs have recesses of different sizes and/or recesses of the same size, the recesses being provided for passing through and influencing the tempering air flow, and the size of the recesses increasing or decreasing in the tempering direction and/or in that the tempering ribs and/or their recesses delimit and/or form one or more tempering air channels at least in regions.

The resistor elements can be arranged in the area of two adjacent tempering ribs and approximately orthogonal to the tempering ribs, whereby the resistor elements are approximately plate-shaped and preferably have one or more openings or recesses.

In the context of the present invention, the resistor elements are also referred to as spacers or spacer elements if, for example, they are arranged orthogonally between two adjacent tempering ribs and keep them at a predetermined distance apart.

The tempering ribs and/or the tempering air guiding elements can form a tempering air channel, preferably tapering in the tempering direction, and/or one or more tempering air ramps.

The tempering body or tempering bodies may be configured as a heat exchanger device, wherein the heat exchanger device may have ribs and/or wherein the ribs of the heat exchanger device may be, at least in part, the tempering ribs.

One or more of the means for influencing the tempering air flow can form one (or more) tempering channels tapering in the tempering direction. Additionally and/or alternatively, it is also conceivable that one or more tempering channels widening in the tempering direction are provided.

By providing a tempering channel, the tempering air can be better used for cooling or heating, since the air distribution, temperature distribution and heat transfer are significantly improved.

Due to a narrowing or tapering tempering channel, the plate-shaped tempering ribs are evenly flowed against and at the same time the thickness of the air boundary layer is locally reduced.

Furthermore, a flow generation device can be provided for forming the tempering air flow and for acting on the means for influencing the tempering air flow in the tempering direction.

In addition, at least one tempering air supply can be provided for applying a stream of tempering air to one or more of the means in a tempering direction from an initial cell of the cell stack to an end cell, and/or at least one tempering air discharge can be provided for discharging the tempering air from the tempering device, the tempering air supply and the tempering air discharge being part of the tempering air guide by means of the tempering channel.

The tempering ribs or the tempering elements can be structurally designed in such a way that the flow resistance of the tempering air guide along the tempering channel increases in the tempering direction, and/or

that all cells can be supplied with approximately the same volume flow (or mass flow) of tempering air, and/or

in that the tempering ribs and/or the tempering elements delimit in sections at least one tempering channel which extends essentially in the tempering direction and whose cross section decreases in the tempering direction, and/or

that a cross-section of the tempering channel tapers in the tempering direction, and/or

that between the tempering ribs and/or the tempering elements and approximately orthogonal to them the resistor elements or spacer elements are arranged, so that heat transfer surfaces of the tempering ribs and/or the tempering bodies and/or the tempering air guide means become larger in the tempering direction, and/or

in that the resistor elements are arranged between the tempering ribs and/or the tempering elements, so that the flow of tempering air to the tempering ribs and/or the tempering elements results in a higher heat transfer from or to the tempering ribs and/or the tempering elements, and/or

in that the tempering bodies are arranged on the tempering ribs and/or the tempering elements, so that a better heat transfer from and to the tempering ribs takes place due to a higher heat transfer surface.

The spacer elements can preferably be provided to increase heat transfer.

The cross-sections and/or number of one or more tempering air supply lines and/or one or more tempering discharge lines can be matched to one another in such a way that the tempering of a cell stack is approximately uniform, and/or that the flow of tempering air to the tempering ribs is automatically regulated and/or controlled by a control device on the basis of operating parameters of the cell stack.

The tempering channel can be bounded in sections transverse to the tempering direction by the tempering air guiding elements and/or by the tempering ribs, a side wall of a cell stack and a housing surrounding the cell stack.

The plate-shaped heat conduction elements can form sealing elements of the cell stack.

The tempering ribs can be electrically insulated from other tempering ribs and/or from heat conduction elements and/or from tempering ribs and/or from resistor elements and/or from tempering bodies.

The electrical insulation can be made electrically insulating by a suitable material, such as micanite, or by an electrically non-conductive coating, such as silicone resin, or electrically non-conductive agents.

In particular, a fuel cell stack can be provided according to the invention. This comprises

several fuel cells connected in series, which form the approximately cuboidal fuel cell stack, wherein

at least one side wall or preferably two, in particular opposite, or three or four side walls are provided with a tempering device according to the invention.

The tempering device may have one or more tempering air inlets and one or more tempering air outlets per side wall of the fuel cell stack.

A temperature sensor for measuring the temperature of the fuel cell stack may be coupled to at least one tempering element.

It is thus possible to achieve an even or homogeneous temperature distribution across all cells of a fuel cell stack, since the heat generated during operation can be dissipated evenly. At present, this is often achieved by means of an additional oil or water cooling system integrated into the cell stack, which is, however, error-prone, complex and expensive. Furthermore, cooling plates are required in the stack for this purpose, which represent an additional weight and cost factor, and often also have to be specially sealed. The tempering device according to the invention, on the other hand, is extremely cost-effective, has a simple design and does not change internal structures of a fuel cell stack, or changes them only slightly.

Furthermore, the tempering device according to the invention allows the installation space in a fuel cell system to be used in a suitable manner if, for example, there is insufficient installation space on a side surface above or below the fuel cell stack for an air supply, distribution, heating device and/or blower device. A fuel cell system is thus easier to set up and takes up less space.

For example, the heating device may be attached to a side wall of the housing of the fuel cell stack. Alternatively, such a blower can be arranged at a distance from the fuel cell stack and coupled to the tempering device via a corresponding duct.

A defined tempering air guide, e.g. by means of the tempering channel, enables uniform temperature distribution (due to air flow). Without such a tempering air guide, there would be a large temperature difference within the fuel cell stack, since the main tempering air flow would be in the tempering direction and several tempering ribs would have little or no air flow. Among other things, the momentum of the gas particles plays a role here.

The tempering channel can be bounded transversely to the tempering direction in sections by the tempering ribs and/or the resistor elements and/or the tempering air guiding elements and/or by one or more tempering bodies and/or a side wall of a fuel cell stack and/or a housing surrounding the fuel cell stack, and wherein the plate-shaped tempering ribs can be integrally formed on plate-shaped heat conduction elements and form tempering elements, and wherein the heat conduction elements can be arranged between individual cells of a fuel cell stack, so that the plate-shaped tempering ribs are mechanically coupled to the fuel cell stack in such a way that the tempering of the fuel cell stack takes place via the plate-shaped heat conduction elements by means of heat conduction, and a tempering of the plate-shaped tempering ribs takes place by means of convection.

The tempering air guiding elements can be formed from individual plate-shaped elements extending approximately or essentially in the tempering direction or parallel to the tempering direction or inclined at an acute angle to the tempering direction. These are referred to below as longitudinal air guiding elements.

The tempering air guiding elements can be formed from individual tempering air guiding elements extending approximately or essentially transverse to the tempering direction or inclined at an obtuse angle relative to the tempering direction. These are referred to below as transverse air guiding elements.

The tempering air guiding elements can, for example, be made of a material such as mi-canite/mica, aluminum, thermally conductive ceramic, high-performance polymer or expanded graphite or, for example, ceramic fiber plates, glass fiber plates or heat pipes. In order to meet the requirements of high strength, low-cost manufacturability, high temperature resistance (e.g. up to 250° C.) and, in addition, non-electrically conductive properties applicable to the tempering air guiding elements of a HT-PEM fuel cell, the choice of material is limited, and the material mi-canite/mica proved to be suitable.

The tempering channel can be formed in one piece or from a plurality of individual interconnected or coupled elements.

In addition to the tempering channel, which is mainly responsible for tempering air distribution or tempering air routing and thus for tempering, the tempering ribs also delimit a large number of tempering distribution channels branching off from the tempering channel, which also play a decisive role in the tempering of a fuel cell stack and are part of the tempering air guide.

The tempering device can have one or more tempering channels with corresponding tempering distribution channels per side wall of the fuel cell stack.

Furthermore, a blower device can be provided for supplying the tempering air guide or the channels with air for tempering.

The plate-shaped heat conduction elements of the tempering elements can form sealing elements for functional units of a fuel cell stack.

In particular, manifold holes forming the gas distribution channels orthogonal to the supply plates can be sealed by the heat conduction elements. For this purpose, webs can be formed in the supply plates which ensure locally increased compression of the heat conduction elements to achieve a high sealing effect.

Furthermore, the material from which the tempering elements are made can be temperature-resistant up to at least 250° C. and, if necessary, phosphoric acid-resistant.

To provide the necessary sealing properties, the tempering element or at least its heat conduction element is preferably made of expanded graphite. The tempering rib can also be made of expanded graphite.

By additionally using the heat conduction elements as flat gaskets instead of, for example, a large number of sealing rings for sealing, the number of sealing elements and thus the probability of assembly errors can be significantly reduced. Graphite is well suited as a sealing material for reformer chambers contained in the stack, since other sealing materials can be problematic (e.g., FKM as a high-temperature elastomer can swell with the methanol in the reformer chambers in combination with internal methanol reforming; FFKM is expensive; silicone is decomposed by phosphoric acid from the HT-PEM fuel cell MEAs; EPDM has too low temperature resistance for HT-PEM fuel cells). The expanded graphite also serves to lower the contact resistance of the reformer chambers (hard plate on hard plate would result in high electrical contact resistance and thus high power loss). Expanded graphite is inexpensive both as a raw material and in processing (e.g. stamping).

In the case of using internal reforming in reformer chambers in a fuel cell stack, the heat conduction elements or the tempering elements can ideally be used both to seal the reformer chambers and to cool the cells.

If the heat conduction elements are made of expanded graphite (e.g. to reduce contact resistance), sealing of the media by sealing rings on the expanded graphite is associated with disadvantages, since both elements (both the sealing ring and the expanded graphite) have a flexible character and local plastic deformation of the expanded graphite as well as creep or settling of the two elements may occur over time. If sealing rings are used as sealing elements, they should therefore advantageously not rest on expanded graphite, which is structurally difficult or impossible, especially in connection with internal reforming, since the reformer chamber is designed with a large surface area in the supply plate and an interruption of the heat conduction element for a sealing track would be disadvantageous for heat conduction.

Thus, the additional function of the heat conduction element or the tempering element as a sealing element is associated with many advantages.

The tempering element, the tempering rib and/or. the heat conduction element can also be formed from another suitable thermally conductive material, such as metal or carbon-polymer compound. In this case, the media can be sealed with elastomer or expanded graphite, for example.

The plate-shaped tempering ribs can be provided with tempering bodies to increase the surface area of the tempering ribs in order to increase convective heat transfer. The tempering bodies can be formed from another heat-conducting material, such as graphite, ceramic or metal. Preferably, these tempering or cooling bodies can be formed of aluminum.

The tempering bodies increase the heat transfer from the tempering ribs to the air.

The tempering bodies can be, for example, aluminum heat exchanger, graphite elements, heat pipes, heat-conducting ceramics, snap-on elements, rivet elements, metal clips, spring elements, metal clips or metal bent parts.

The tempering bodies can be attached to or connected with the tempering ribs, for example, by spring force, bonding, clamps, screws or rivets.

For example, spring-loaded bent/pressure-formed steel, copper, brass or aluminum parts can be clamped to the tempering ribs as tempering bodies. The spring force can ensure good heat transfer between the air conduction element and the tempering body.

In one embodiment, individual tabs of a plate-shaped tempering body (for example, made of copper-bearing metal) may alternately rest on one side and the other side of an air guiding element, thereby providing a thermally conductive connection thereto by spring force and forming a high heat transfer surface to the air by curved design.

In another embodiment, extruded aluminum heat sinks, for example, can be riveted, clamped or screwed to tempering ribs as tempering bodies.

If the tempering elements, tempering ribs and/or tempering bodies are electrically insulating, they can contact several tempering elements, tempering ribs and/or tempering bodies arranged one after the other in the tempering direction. In this way, heat exchange or equalization between these elements is enabled, so that more efficient tempering of a fuel cell stack with good temperature distribution is possible.

Spacers or spacer structures, in particular resistor elements, can be arranged between two adjacent tempering ribs.

The resistor elements or spacer structures can be provided for positioning or aligning or centering the tempering ribs in order to compensate for linear expansion of the fuel cell stack and/or manufacturing tolerances. This is particularly possible if the tempering ribs are made of expanded graphite, which is sufficiently flexible and can be bent easily.

The resistor elements or spacer structures can extend orthogonally to the tempering ribs, can serve to position and/or space tempering ribs, and can, for example, prevent large gaps from occurring between adjacent tempering ribs, for example due to unintentional bending of tempering ribs during assembly or due to thermal expansion of the fuel cell stack components during operation. Such gaps would increase the boundary layer thickness for heat transfer and thus possibly negatively influence it. Gaps between tempering ribs that are too small can also be avoided with the aid of spacer structures.

The spacer structures can also be used to prevent electrical contact between adjacent tempering ribs if the tempering ribs are electrically conductive.

The resistor elements can be arranged between the tempering ribs, in particular to influence the air flow.

The resistor elements or the spacer structures can be used or provided to influence the flow of the tempering air, e.g. to form a turbulent flow. For this purpose, the spacer structures and/or resistor elements can also have recesses and/or holes for influencing the flow of the tempering air.

The resistor elements or the spacer structures can also be used to selectively influence the pressure drop of the air flow so that the temperature distribution of the fuel cell stack is more uniform.

For this purpose, the resistor elements or the spacer structures can, for example, by means of correspondingly smaller cutouts or openings or smaller distances to tempering ribs, aim locally at certain cells to achieve a higher pressure drop at a given volume flow in contrast to the cutouts at other cells. Also, the differential pressure between air supply and air exhaust can be increased overall by the spacer structures or resistor elements at a given volume flow (for example, by correspondingly small flow cross sections at the spacer structures or resistor elements) in order to influence the temperature distribution of the fuel cell stack in a desired manner and/or to make it less sensitive to tolerances in the air flow or other parameters that lead to a deviation of the pressure drop.

If the distance between the resistor elements or spacer structures and the tempering ribs shall be approximately constant for a defined flow cross section (for example, even when the fuel cell stack with the tempering elements expands during heating), elements formed on or attached to the spacer structures or resistor elements can be used to maintain the distance.

The resistor elements or the spacer structures can, for example, be formed from the material mica or micanite or from ceramic or glass fiber plate. Furthermore, these can be formed, for example, from metal or expanded graphite, whereby these can be coated in an electrically insulating manner.

The tempering ribs can also have the function of tempering bodies and/or resistor elements, or tempering bodies and/or resistor elements can be integrally formed on the tempering ribs.

The tempering ribs can form several tempering channels which extend in and/or transverse to the tempering direction.

In this way, depending on the geometry of a fuel cell stack, a homogeneous temperature distribution can be achieved by providing the multiple tempering channels.

Furthermore, according to the invention, a fuel cell stack with such a tempering device is provided. This comprises

several fuel cells connected in series, which form the approximately cuboidal fuel cell stack, whereby

at least one side wall or preferably two, in particular opposite, or three or four side walls are provided with a tempering device described above.

The advantages that can be achieved in this way have been demonstrated above on the basis of the tempering device and apply analogously to a fuel cell stack equipped with such a tempering device.

The invention is explained in more detail below with reference to the drawings. These show in:

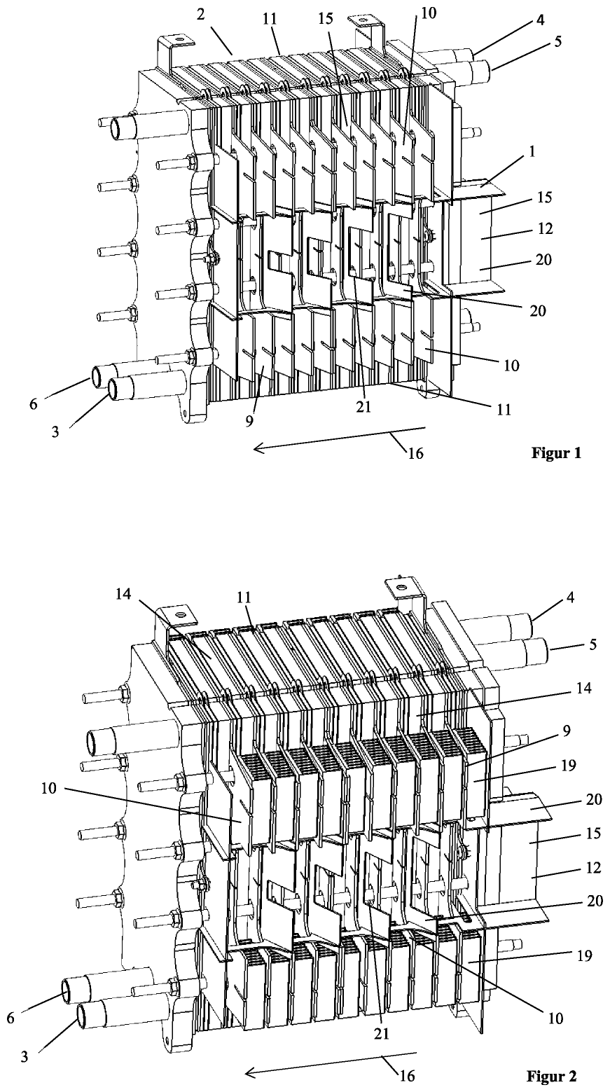

FIG. 1 a schematic, perspective view of a first embodiment of a fuel cell stack with a tempering device according to the invention,

FIG. 2 a schematic, perspective view of a second embodiment of a fuel cell stack with a tempering device according to the invention,

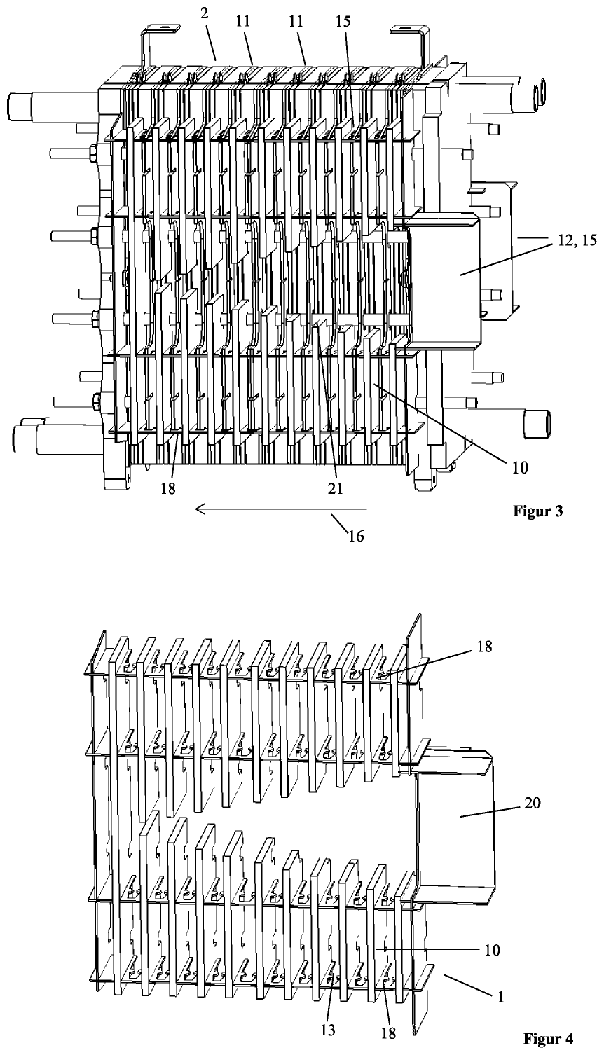

FIG. 3 a schematic, perspective view of a third embodiment of a fuel cell stack with a tempering device according to the invention,

FIG. 4 a schematic, perspective view of the tempering device according to the invention from FIG. 3,

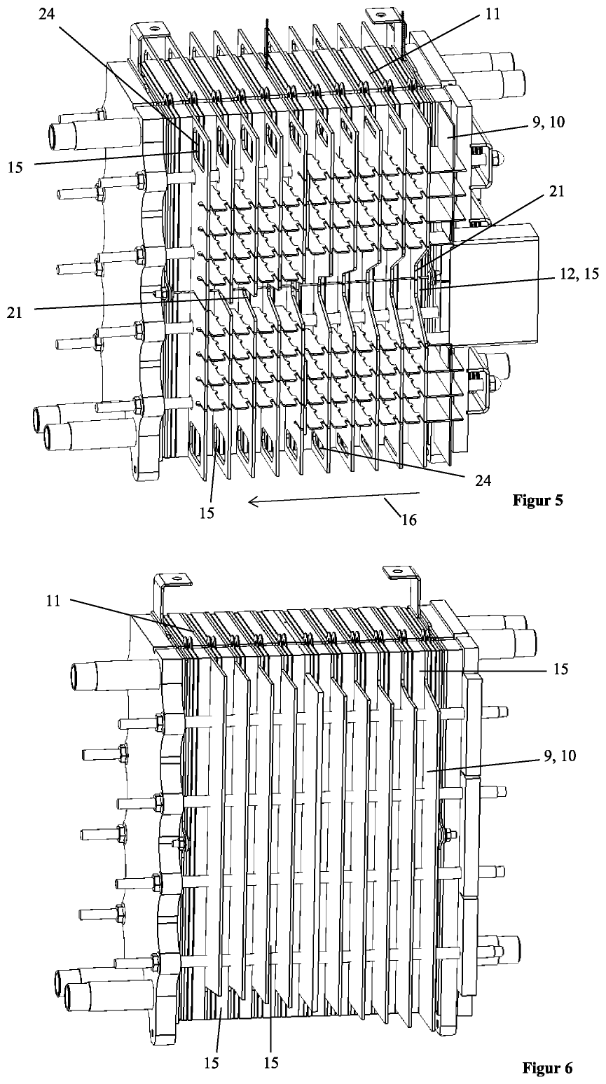

FIG. 5 a schematic, perspective view of a further embodiment of a fuel cell stack with a tempering device according to the invention,

FIG. 6 a schematic, perspective view of a further embodiment of a fuel cell stack with a tempering device according to the invention,

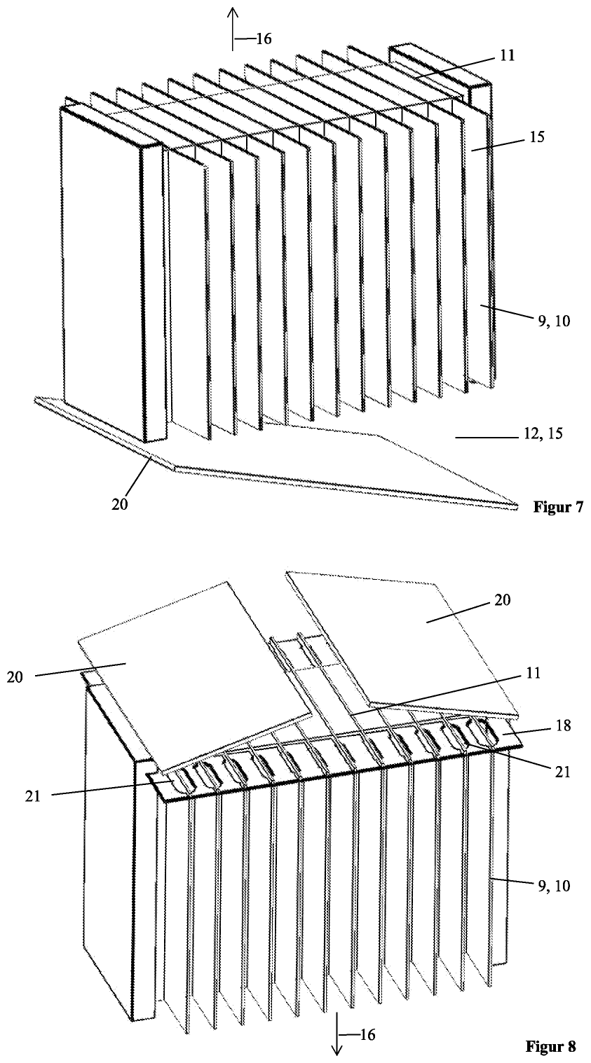

FIG. 7a schematic, perspective view of a further embodiment of a fuel cell stack with a tempering device according to the invention,

FIG. 8a schematic, perspective view of a further embodiment of a fuel cell stack with a tempering device according to the invention,

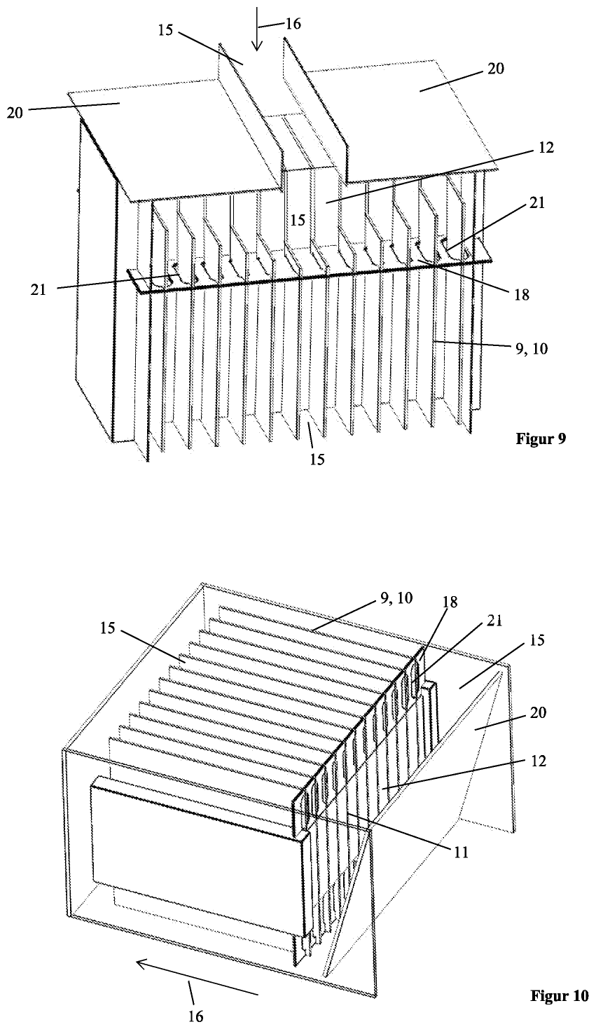

FIG. 9a schematic, perspective view of a further embodiment of a fuel cell stack with a tempering device according to the invention,

FIG. 10a schematic, perspective view of a further embodiment of a fuel cell stack with a tempering device according to the invention,

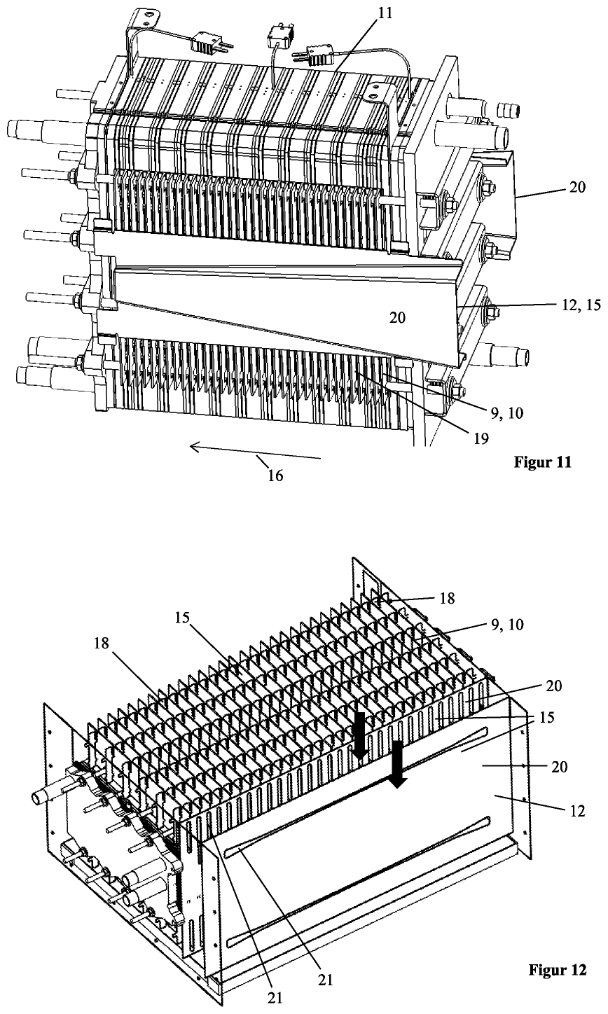

FIG. 11a schematic, perspective view of a further embodiment of a fuel cell stack with a tempering device according to the invention,

FIG. 12 a schematic, perspective view of a further embodiment of a fuel cell stack with a tempering device according to the invention,

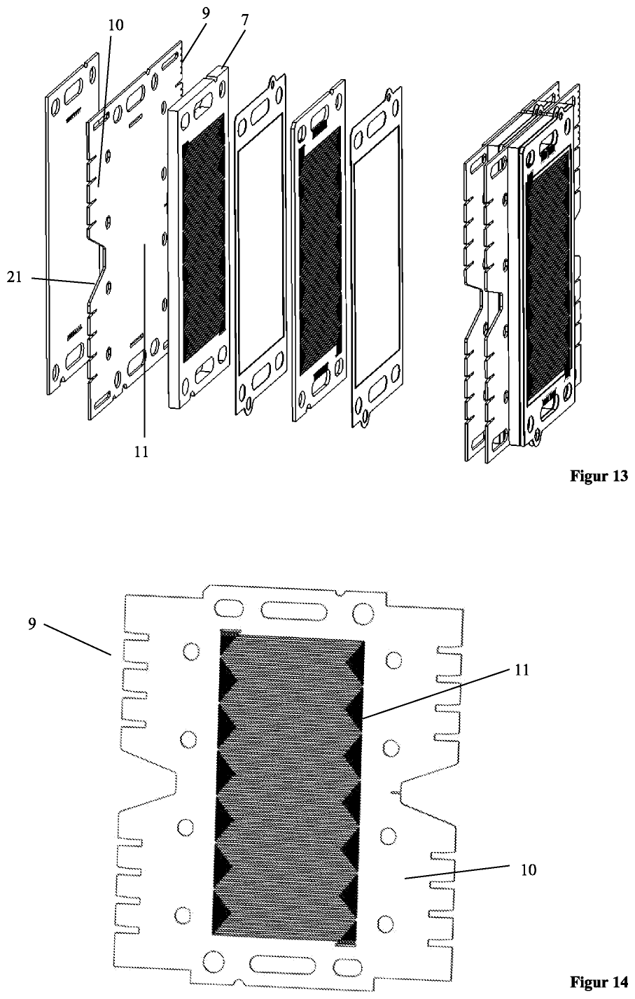

FIG. 13 a schematic exploded view of plate-shaped elements of a fuel cell stack, and

FIG. 14 a detailed perspective view of a gas distribution structure of FIG. 13.

In the following, a fuel cell stack 2 is described by way of example, which is provided with a tempering device 1 according to the invention (FIGS. 1 to 3 and 5 to 12).

The fuel cell stack 2 with internal reforming is similar in design to the fuel cell stack described in WO 2015/110545 A1. In this document, which is hereby referred to in full, a fuel cell system for thermally coupled reforming with reformate processing is described. This system includes a fuel cell stack having an anode inlet, an anode outlet, a cathode inlet, and a cathode outlet, and a steam reforming reformer thermally coupled to the fuel cell stack for providing an anode fluid comprising reformed fuel upstream of the anode inlet. The fuel cell stack and the reformer device are thermally coupled in such a way that the waste heat of the fuel cell stack is transferred by means of heat conduction to the reformer device in such a way and is used at least partially for operating the reformer device, and at least one processing device arranged between the reformer device and the anode inlet being provided for removing and/or reforming unreformed fuel and/or substances harmful to the fuel cell stack from the anode fluid, an operating temperature of the fuel cell stack being in the range between 140° C. and 230° C.

The fuel cell stack 2 is designed as an HT-PEMFC (high-temperature polymer electrolyte fuel cell). This high-temperature fuel cell operates in a temperature range of 160° C.-180° C. and up to 230° C., respectively. The hydrogen required is obtained from methanol by an internal and an external reforming process and converted into electricity in the fuel cell stack.

In principle, the tempering device 1 according to the invention can be used with all types of devices described at the beginning, in particular fuel cell stacks.

According to a first embodiment example, a corresponding fuel cell system (not shown) comprises fuel cell stack 2 with an anode inlet 3 and an anode outlet 4 and a cathode inlet 5 and a cathode outlet 6.

Furthermore, a reformer device 7 thermally coupled to the fuel cell stack 2 for providing reformate or anode fluid is provided, which is connected upstream of the anode inlet 3, and a treatment device (not shown) arranged outside the cell stack between the reformer device 7 and the anode inlet 3 for removing untreated fuel and harmful substances from the reformate.

In the following, a structure of a “repeating unit” 8 is explained as an example, which in the present case describes two cells of a fuel cell stack 2 composed of several cells.

First, a plate-shaped tempering element 9 of the tempering device 1 is provided.

This tempering element 9 is formed from a plate-shaped tempering rib 10 and a plate-shaped heat conduction element 11 integrally formed thereon.

Because the heat conduction elements 11 can be arranged between individual cells of a fuel cell stack 2, the plate-shaped tempering ribs 10 are mechanically coupled to the fuel cell stack 2 in such a way that the temperature of the fuel cell stack 2 is controlled via the plate-shaped heat conduction elements 11 by means of heat conduction, and the temperature of the plate-shaped tempering ribs 10 is controlled by flowing or being acted upon by tempering air by means of convection.

The reformer unit 7 is connected to the tempering element 9.

The reformer device 7 is integrated into a supply plate 17 of a fuel cell stack 2. One side of the supply plate is provided with a meandering distribution structure, called a flowfield, for an anode fluid (or correspondingly for a cathode fluid).

A reformer chamber of the reformer device 7 is formed on the side of the supply plate opposite the distributor structure for the anode fluid. Such a plate is referred to below as a reformer monopolar plate with reformer chamber or as a monopolar plate with reformer chamber.

The reformer chamber has an inlet for supplying the carrier gas containing gaseous fuel and an outlet for discharging the reformate formed from the gaseous fuel and the carrier gas. A reformer catalyst (not shown) is arranged in the reformer chamber and is uniformly distributed over the entire reformer chamber. Between the inlet or the outlet and the reformer chamber, a barrier is formed, for example in the form of a mesh made of the material PEEK or channels or webs, which prevents the reformer catalyst from escaping from the reformer chamber into the inlet and the outlet when the system is moved. Furthermore, cuboidal bodies or webs made of the supply plate, for example, are provided in the reformer chamber to ensure uniform distribution of the reformer catalyst as well as the gas. These also serve to form an electrically and thermally conductive connection between the supply plates and to ensure the mechanical stability of the supply plates and thus of the fuel cell stack.

The distributor structure for the anode fluid is followed by one or more sealing elements, gas diffusion layers, catalyst layers, and an electrolyte-containing membrane (membrane electrode assembly, MEA).

This is followed by a supply plate, which is provided on both sides with spatially separated, for example meandering, distributor structures. One side has a distributor structure for a cathode fluid and the other side has a distributor structure for an anode fluid. Such a plate is referred to below as a bipolar plate.

This is followed by one or more sealing elements, gas diffusion layers and catalyst layers as well as an electrolyte-containing membrane (MEA) and a supply plate 17 as a monopolar plate with cathode flowfield. This completes the construction of the repeating unit comprising a tempering element 9 and two cells.

By stringing together a number of repeating units 8, a fuel cell stack 2 can be formed with any number of cells, according to the desired power.

According to a first embodiment example (FIG. 1), the tempering air guide 12 comprises at least the tempering channel 15, which extends essentially in a tempering direction 16 and whose cross section decreases or tapers conically in the tempering direction 16, so that individual cells of the fuel cell stack 2 can be heated or cooled approximately uniformly.

Several plate-shaped tempering ribs 10 are arranged approximately orthogonally to a side wall 14 of the fuel cell stack 2 and thermally coupled to it. The tempering ribs 10 have axially aligned cutouts 13 in the tempering direction 16.

Plate-shaped tempering air guiding elements 10 are provided in the cutouts 13 of the tempering ribs, which are arranged at a predetermined angle with respect to the side wall 14 of the fuel cell stack 2 and delimit a tempering channel 15 of the tempering air guide 12. The angle can be, for example, at least 25° or 30° or 40° or 50° or a maximum of 70° or 80° or 90° and preferably a maximum of 60°.

The tempering channel 15 is bounded by recesses 21 formed in the tempering air guiding elements 20, a side wall 14 of the fuel cell stack 2, and a housing (not shown) surrounding the fuel cell stack. The housing may be provided with thermal insulation.

In order to be able to optimally dissipate the heat of the fuel cell stack 2, in the context of the present invention the tempering device 1 is provided with its tempering elements 9 and a corresponding blower device (not shown) for applying a tempering medium (preferably air) to the at least one tempering channel 15.

The tempering device 1 has at least one or two or three or four or five or six or seven or eight or more main tempering channels 22. The main tempering channels 22 are preferably equally spaced from one another in the lateral direction and are arranged mirror-symmetrically or symmetrically along a jacket wall or along the side walls 14 of the fuel cell stack 2.

In addition, a tempering air supply 23 is provided, which is also part of the tempering air guide 12.

The tempering elements 9 can also be designed as a thermally conductive seal to seal individual components or functional units or repeating units 8 of a fuel cell stack 2.

This gasket can be, for example, a graphitic material with sufficient thermal conductivity, or in the case of a metallic fuel cell stack 2, a corresponding metallic gasket.

In an alternative embodiment of the invention, provision may be made to integrate an anode and/or cathode distribution structure into the heat conduction elements 11 or to form corresponding components (e.g. heat conduction element and cathode and/or anode monopolar plate) in one piece. The tempering element can, for example, additionally assume the functions of the supply plate(s) (including gas distribution or fluid supply of a fuel cell MEA).

A gas distribution structure (flowfield) can be pressed into a tempering element which is made of a deformable material and has at least one tempering rib (FIGS. 13 and 14). This has several advantages: on the one hand, a monopolar plate or bipolar plate can be saved in each case, which leads to cost advantages (the plates with channel structure are high-priced), and on the other hand, sealing surfaces can be saved, thus reducing the risk of leaks and costs for sealing materials. Furthermore, there is a lower heat gradient, since no heat transfer from a monopolar plate or bipolar plate to the tempering element is necessary for heat transfer. Thus, a better temperature distribution and lower energy consumption for cooling can be achieved. In addition, the fuel cell stack becomes shorter since fewer plates are required. At the same time, good heat conduction within the heat conduction element is ensured even with pressed-in channels, which is partly due to the fact that pressing or rolling channel structures into the tempering element does not reduce the amount of material (but only compresses it more) compared to machining, for example. It is also possible to dispense with seals. Thus, the tempering element can simultaneously fulfill the function of the MEA seal. For example, a tempering element made of a deformable material and a plate or tempering element made of a non-deformable material can be adjacent to a membrane electrode assembly (MEA). Also, two plates or tempering elements made of a deformable material can be adjacent to the MEA, sealing the MEA from both sides, for example. Another advantage is that the plates with embossed supply channels can be produced more cheaply, since embossing channels into flat material can be less expensive than, for example, milling channels out of a plate or producing them by injection molding or compression molding.

One or more plates, in which channels are pressed in and which, among other things, fulfill the function of a monopolar plate or bipolar plate, may be provided in the cell stack.

The material of the plates, heat conduction elements, tempering ribs or tempering elements into which structures or channels are pressed can, for example, be expanded graphite, which is obtained as a flat plate and into which structures or channels are introduced by rolling, hammering, embossing or pressing. The embossing of the channels can also be accompanied or implemented by a stamping-forming process. The material is preferably electrically conductive and can have a material thickness of, for example, 1 to 4 mm, preferably 1.5 mm, 2 mm, 2.5 mm or 3 mm, so that channels with channel depths of more than 0.2 mm, preferably more than 0.6 mm, can be embossed under high mechanical pressure and so that, at the same time, either no elevations or elevations with a height of less than 0.4 mm, preferably less than 0.1 mm, are formed next to and/or opposite the embossing. The thermal conductivity of the heat conduction element or tempering element is above 50 W/mK, preferably above 100 W/mK or above 150 W/mK. The material does not necessarily have to include a binder or plastics (e.g. thermoplastic or curing resin), but can (in contrast to injection molding or compression molding) consist, for example, of over 99 percent carbon. Graphite with a concentration above 99 percent is more chemically and thermally resistant than carbon plastic compounds, which is advantageous for high durability. Pressing in the channels or structures, for example, can be carried out at temperatures below 100° C., preferably below 40° C. The pressure for pressing in structures or channels can be above 10 MPa, preferably between 15 and 300 MPa. The electrical resistivity (in through-plane direction) of the material of the tempering element or heat conduction element is below 0.1 ohm*cm, preferably below 0.04 ohm*cm or below 0.02 ohm*cm. A common fuel cell bipolar plate material made of carbon-polymer compound would be very brittle, fragile and strong at this low resistivity, so that channels could not be imprinted at temperatures below 100° C. For this reason, a deformable material such as expanded graphite, which is commonly used for flat gaskets in flanges, must be used. The structures or channels may be embossed into the plate on either one or both sides. If necessary, the plates, tempering elements or heat conduction elements can be chemically or physically treated, impregnated or coated to avoid strong absorption of electrolyte, for example from a fuel cell MEA, and where the electrical resistance to the MEA must be below 50 mOhm/cm². In the tempering ribs, the embossing of structures can serve, for example, to increase heat transfer to air or another material. For example, a metallic frame can be contacted to a heat conduction element containing embossed channels, which serves as a tempering rib. The metallic frame or a metallic molded part or a thermally conductive plate may be attached to the heat conducting element containing impressed channels, for example, by clamping. Thermal contact may also be made by soldering or welding material to the inner edges of the metallic frame so that positive and/or frictional engagement with the tempering element or heat conduction element is created, and portions of the metallic sheet may be provided to press into the deformable tempering element or heat conduction element. If a reformer chamber is adjacent to the plate with impressed supply channels, a better heat transfer from the MEA to the reformer chamber can take place, since there is no monopolar plate or bipolar plate between the MEA and the reformer chamber, but for example only a heat conduction element.

A fuel cell stack can thus be provided which is characterized in that one or more heat conduction elements and/or tempering elements are formed from a material, preferably “expanded graphite”. Whereby the material is deformable at a temperature below 80° C. In addition, the material has an electrical through-plane resistivity of less than 0.1 ohm*cm. In particular, channel structures for a fluid supply are formed in the heat conduction elements and/or the tempering elements, which are produced by embossing in the deformable material.

To ensure the removal of the heat generated, an air flow is provided around the stack to remove the excess heat from the system. The excess heat can also be used as waste heat.

The fuel cell stack may also be combined with one or more other cell stacks. For example, a reformer stack may be attached to or braced with the fuel cell stack. In this case, the tempering device may be formed either on the combination of stacks or separately for each stack.

Unless otherwise described, all embodiments of the present invention have the same technical features. The technical features of the individual embodiment examples can be combined with each other almost arbitrarily.

According to a second embodiment (FIG. 2), the plate-shaped tempering ribs 10 of the tempering elements 9 are provided with tempering bodies 19 for increasing the surface area of the tempering ribs 10 in order to increase convective heat transfer.

According to a third embodiment (FIG. 3) of the tempering device 1 according to the invention, the tempering ribs 10 are not integrally connected to the heat conduction elements 11, but are formed separately therefrom. In the context of the present invention, tempering air guiding elements 20 can also be provided in place of these tempering ribs 10.

Similar to the first and second embodiments, the tempering ribs 10 have cutouts 13 that form a tempering channel that tapers in the tempering direction 16.

The individual tempering ribs 10 are connected to each other by resistor elements 18 extending transversely to the tempering ribs 10 and running approximately in the tempering direction. The resistor elements 18 serve as spacers and have corresponding recesses 25 for the pas-sage of the tempering air flow.

An advantage of such a tempering device is that it can be easily attached to a side wall, for example of a fuel cell stack (FIG. 4).

Such a tempering device 1 is advantageous in that the narrowing flow cross-sections at the tempering ribs promote the flow to the fins by reducing the air boundary layer.

In a further embodiment (FIG. 5) of the tempering device according to the invention, the tempering ribs 10 again have cutouts 13 which taper in the tempering direction 16. In addition, resistor elements 18 are arranged as spacers between the individual tempering ribs for spaced arrangement and for changing the air flow.

In particular, the edge regions of the tempering ribs 10 have through holes 24 that increase in size in the tempering direction 16.

Due to the through holes 24 increasing in the tempering direction, the largest possible surface area of the tempering ribs 10 can be realized for the air discharge despite the small installation space. The less air has to be removed orthogonally to the respective tempering rib, the smaller the recess in the tempering rib and the pressure loss of the outflowing air flow is only in-significantly higher than if all tempering ribs had recesses of the same size. Furthermore, the size of the recesses can serve for the volume flow distribution.

In addition, resistor elements 18 are provided between the tempering ribs 10. The resistor elements 18 can have a comb-like design. Micanite (mica) can preferably be used as the material. These also serve to reduce the air boundary layer, in particular by means of a narrow gap provided between the resistor elements 18 and the tempering ribs 10. Furthermore, they contribute to the formation of turbulence and vortices and thus to the increase of the pressure drop. A higher pressure drop favors a more uniform pressure distribution over the entire fuel cell stack.

According to another embodiment (FIG. 6), the tempering ribs 10 are arranged offset from one another in the tempering direction 16. A blower device (not shown) initially acts on a tempering channel 15.1 which tapers in the tempering direction, with the tempering air then flowing along the tempering ribs into a tempering channel 15.2 which increases in the tempering direction 16.

According to another embodiment of the tempering device 1 (FIG. 7), corresponding tempering ribs 10 are provided on two opposite sides of a fuel cell stack 2.

On one wall of the fuel cell stack 2 arranged between the two side walls which are provided with tempering ribs, a tempering air guiding element 20 is provided which is inclined relative to the tempering direction in such a way that it forms a tempering channel 15 tapering in the tempering direction. The technical effect of such a tempering channel corresponds approximately to the tempering channels 15.1, 15.2 tapering in the tempering direction shown above.

In a further embodiment of the tempering device 1 according to the invention (FIG. 8), it is also provided that the tempering ribs 10 are formed on two opposing side walls 14 of the fuel cell stack 2.

Furthermore, resistor elements 18 are provided between the tempering ribs 10. These have recesses 25 which extend into the tempering channels 15 formed between the tempering ribs 10. Preferably, the diameter of the recesses 25 increases from a center of a corresponding fuel cell stack 2 to outer edge regions.

In addition, two tempering air guiding elements 20 are provided which are inclined approximately like a roof or relative to a side wall of the fuel cell stack 2. These are arranged approximately centrally at a distance from one another. It is provided that a blower device (not shown) introduces the tempering air into a free space between the two tempering air guiding elements 20. The tempering air is then distributed via the corresponding recesses 25 into the tempering channels 15 formed between the tempering ribs 10, so that uniform temperature control of a fuel cell stack 2 is again possible.

According to a further embodiment of the tempering device according to the invention (FIG. 9), tempering ribs 10 are provided on two opposite sides 14 of the fuel cell stack 2.

Two tempering air guiding elements 20 are arranged on a further side wall 14, extending substantially parallel to this side wall 14 and forming a tempering air supply 23 and part of a tempering air guide 12.

The tempering air reaches the area of the tempering ribs 10 via the spaced arrangement between the two tempering air guiding elements 20. Here, it is provided that the tempering ribs delimit a tempering channel 15 which tapers towards both end areas of the fuel cell stack 2.

Furthermore, a resistor element 18 is provided for holding the tempering ribs 10 at a distance, which is arranged transversely to the tempering ribs 10 and has recesses 25 in the region of the tempering ribs 10 for passing the tempering air through.

In another embodiment of the tempering device (FIG. 10), tempering ribs 10 are again provided on two opposing side walls 14 of the fuel cell stack 2.

In addition, at least one resistor element 18 or spacer element is provided per side for holding the tempering ribs 10 at a distance, with corresponding recesses 25 being formed in the resistor elements 18, in the area of the tempering ribs 10. Several such resistor elements 18 may also be provided.

In that the resistor elements have recesses 25 which increase in size in the direction of the edge regions of the fuel cell stack and a tempering air guiding element is provided which is inclined relative to a side wall of the fuel cell stack 2 in such a way that in the region of a tempering air inlet a greater distance is provided between the tempering air guiding element 20 and the fuel cell stack, that in the region of a tempering air inlet a greater spacing is provided between the tempering air guiding element 20 and the fuel cell stack, a tempering channel 15 tapering transversely to the tempering direction 16 is formed, the tempering channel 15 or a corresponding tempering air guide 12 additionally comprising the corresponding intermediate spaces between the tempering ribs.

By providing different sized recesses 21 in the resistor elements 18, uniform tempering of a fuel cell stack 2 is again possible.

According to a further embodiment of a tempering device 1 according to the invention (FIG. 11), no individual tempering ribs 10 are provided. A large tempering body 19 extending essentially over an entire side wall 14 of a fuel cell stack 2 is provided for contacting the heat conduction elements and comprises the tempering ribs 10. By means of a plurality of interconnected tempering air guiding elements 20, a shaft-like tempering channel 15 tapering in the tempering direction 16 is formed, which also forms the tempering air supply 23.

In this case, it may also be necessary to insulate the tempering body 19, which is de-signed as an aluminum heat sink, for example, from the fuel cell stack by means of a heat-conducting foil in order to avoid short circuits.

According to a further embodiment of a tempering device 1 according to the invention (FIG. 12), it is provided that tempering ribs 10 are provided on two mutually opposite sides 14 of the fuel cell stack 2.

Two tempering air guiding elements 20 are arranged on another side wall 14, extending substantially parallel to this side wall 14 and forming a tempering air supply 23 and part of a tempering air guide 12.

When the cell stack is heated, the hot air flows through the two tempering air guiding elements. The front tempering air guiding element is primarily used to distribute the hot air during heating of the cell stack. When the cell stack is being cooled during operation, however, air does not flow through the front tempering air guiding element, or only slightly, but primarily through the rear tempering air guiding element. The front tempering air guiding element is primarily used to distribute the hot air (larger recesses in the area of the edge cells due to the higher heat requirement at the edge cells because of the high heat capacity of the end plates/clamping components and, if necessary, heat dissipation there). The rear tempering air guiding element is primarily used to distribute the cooling air. The hot air flows in front of the front tempering air guiding element. The cooling air flows in between the front and rear tempering air guiding elements.

Furthermore, resistor elements 18 are provided for holding the tempering ribs 10 at a distance, which are arranged transversely to the tempering ribs 10 and have recesses 25 in the region of the tempering ribs 10 for passing the tempering air, whereby the resistor elements serve to increase the heat transfer by bringing the air to the tempering ribs and/or creating turbulence.

The spacer or resistor elements and, if applicable, the tempering ribs, which are located underneath the cell stack, also have the function of transferring the weight of the cell stack to the enclosure.

The present invention is combinable with a burner system for providing thermal energy. Such an apparatus includes vaporizer means for vaporizing a liquid fuel,

a burner air supply device,

a burner means for burning a fuel mixture comprising vaporized fuel and burner air to provide an exhaust gas stream,

a functional device for controlling the thermal energy of the exhaust gas flow, the burner device providing, in operation, the thermal energy for complete vaporization of the fuel in the vaporizer device.

Furthermore, the burner system includes the tertiary air device and a metering orifice.

The tertiary air device includes a PWM (pulse width modulation)-capable radial fan. The PWM enables precise adjustment of the fan speed and thus a controlled flow of tertiary air. A sensor line provides information on the current fan speed and can indicate a fan failure by means of a logic check.

In addition to cooling the fuel cell, the tertiary fan heats the fuel cell by the hot exhaust air (hot gas flow comprising exhaust gas flow and tertiary air) from the burner device. The fan enables sufficient cooling of a fuel cell stack at any operating point (different power levels).

The fuel cell stack may be formed of identical units, with a unit comprising, for example, each of the following components,

Tempering element (sealing element), monopolar plate (separator plate) with anode flow-field, MEA, bipolar plate with anode and cathode flowfield, MEA, monopolar plate with cathode flowfield, or

Tempering element (sealing element), reformer monopolar plate with reformer chamber and anode flowfield, MEA, bipolar plate with anode and cathode flowfield, MEA, monopolar plate with cathode flowfield, or

Tempering element (sealing element), monopolar plate with anode flowfield, MEA, mono-polar plate with cathode flowfield), or

Tempering element (sealing element), monopolar plate (separator plate) with anode flow-field, MEA, bipolar plate with anode and cathode flowfield, MEA, bipolar plate with anode and cathode flowfield, MEA, monopolar plate with cathode flowfield, or

Tempering element, reformer monopolar plate with reformer chamber and anode flowfield, MEA, bipolar plate with anode and cathode flowfield, MEA, reformer monopolar plate with reformer chamber and cathode flowfield, or

Tempering element, reformer monopolar plate with reformer chamber and cathode flow-field, MEA, bipolar plate with anode and cathode flowfield, MEA, monopolar plate with anode flowfield.

The supply plates, monopolar plates, bipolar plates, heat conduction elements or tempering elements can, for example, be made of carbon-polymer compound (formed, for example, by injection molding, compression molding, extrusion, rolling, stamping), expanded graphite, flexible car-bon-containing material or metal. Where appropriate, these may be bonded to each other and/or to other components, for example by welding.

The fuel cell stack may also contain, among other things, bracing elements (e.g. end plates) as well as gas and power connection elements and insulation plates/foils (e.g. for electrical insulation).

Depending on the structure of the fuel cell stack, the tempering elements can be designed as sealing elements. However, a sealing effect is not absolutely necessary. If the heat conduction elements are made of metal, for example, then separate seals or sealing frames can also be used.

In normal polymer electrolyte fuel cells, hydrogen generation (internal reforming) integrated into the stack (fuel cell stack) is normally not possible due to the low temperatures. How-ever, the higher temperatures up to approx. 200° C. in a HT-PEM fuel cell make it possible to use this process, which is mainly known in the field of SOFC and MCFC.

Therefore, instead of the cooling plates normally used, corresponding reformer chambers (reaction chambers) can be integrated in the stack in a uniformly recurring sequence.

A good temperature distribution of the fuel cell stack (for example, plus/minus 5 Kelvin) is particularly significant when internal reforming takes place in the fuel cell stack. A deviation of the temperature of different reformer chambers within the fuel cell stack of more than 5 Kelvin would result in a significant deviation (for example by more than 10 percent) of the reformer con-version of the internal reforming in the respective reformer chamber. Assuming that a conversion of 50% is to be achieved in the fuel cell stack, a deviation of the conversion of far more than plus/minus 10 percent in some reformer chambers would lead to a high inefficiency of the internal reforming and the reformer chambers or reformer catalyst quantity would have to be designed larger.

Assuming that a conversion of more than 98% is to be achieved in the fuel cell stack in order to save post-cleaning or post-reforming, falling below the target conversion by much more than 10% in some reformer rooms would result in damage to the fuel cell stack if substances harmful to the fuel cell, such as methanol, are conducted to the fuel cell anodes of the cells.

Consequently, the internal reformer chambers or the reformer catalyst volume would have to be designed significantly larger (for example, by more than 50 percent) in the case of a non-uniform temperature distribution than in the case of a uniform temperature distribution of the fuel cell stack, which would have a significant negative impact on the costs and/or the necessary installation space.

Furthermore, hotter reformer chambers would result in a higher carbon monoxide concentration in the product gas, which negatively affects cell performance by poisoning the fuel cell catalyst surface.

In an advantageous embodiment, the reformer compartments are interconnected by an inlet and outlet integrated into the fuel cell stack, but spatially separated from the anode and cathode ports, and must be sealed from the outside.

Preferably, the tempering elements or their plate-shaped heat conduction elements can be used to seal the reformer chambers.

A suitable reaction accelerator is used to accelerate the reaction taking place in them. In an advantageous embodiment of the invention, this is a copper catalyst which is in the form of pellets or one or more shaped bodies.

The endothermic reaction described above, provided that heat exchange takes place by integrating the reaction spaces into the stack, contributes to the cooling of the stack. However, cooling of the stack by such a process alone is not sufficient. Therefore, the tempering device according to the invention is required.

The tempering device can also be used for fuel cell stacks without internal reforming.

One or more temperature sensors can be provided in the fuel cell stack. These can be located, for example, in the center of the fuel cell stack as well as on the initial cell and on the final cell. The temperature sensors may be thermocouples, for example, positioned adjacent to the center of the respective cell. The temperature sensor can be integrated in a heat conduction element, for example it can be pressed into a slot in the heat conduction element. On the first and last cells, the temperature sensors can also be located in the outer area, i.e. not in the area of the cell center, in order to be able to approximately map the minimum temperature of the fuel cell stack during heating.

The setpoint temperature of the fuel cell stack during fuel cell operation can, for example, be controlled by the fuel cell system via the blower device on the basis of the temperature sensor in the center of the fuel cell stack or via the mean value of the measured values of several temperature sensors in and/or on the fuel cell stack or on the basis of a temperature sensor making thermal contact with a tempering element.

A thermocouple for measuring the temperature of the fuel cell stack can be coupled to at least one tempering element. By means of the thermocouple, the temperature of the fuel cell stack can be measured in any operating state. Accordingly, the tempering device can be controlled to set the desired temperature in the fuel cell stack.

For an approximately uniform temperature distribution within the fuel cell stack (for example, with one hundred cells) during fuel cell operation, an approximately equal heat flow from each individual cell to the cooling air or from the heating air to each individual cell is usually required, especially at the cells not located near the initial or final cell (for example, not at the first four or last four cells). The heat flux has the unit watt.

Here it is assumed that all cells of the fuel cell stack, for example, generate approximately the same waste heat during operation under the same conditions due to approximately the same potential with a given electric current flow through all cells (same power of all cells). In this case, the waste heat and thus the heat flux to be dissipated from the individual cells should vary by less than plus/minus seven percent from the average value under the same conditions. If this is not the case due to higher power fluctuations of the fuel cell units, different heat flows would be necessary for a uniform temperature distribution of the cells (for example, more than plus/minus seven percent deviation of the heat flow).

In addition, during fuel cell operation, the gas flow of the media within the fuel cell stack (for example, in the manifolds or flowfields) can also have a small effect on the heat flows and/or temperature distribution. For example, the cathode air in the manifold warms up from the first to the last cell or from the last to the first cell. This can be taken into account with the air routing.

The transfer (e.g. via thermal radiation, convection, thermal conduction) of heat from the fuel cell stack to the air outside the tempering device or to components that are not part of the tempering device can also be taken into account by the air routing of the tempering device, if this makes sense.

The dissipation or supply of heat from individual cells or to individual cells of the fuel cell stack can take place either by direct thermal contact of the respective cells to one or more heat conduction element(s) or indirectly via heat conduction through one or more adjacent cells and/or via components (e.g. spacer structures, resistor elements, heat sinks, tempering elements, air guiding elements) from or to one or more tempering element(s) or tempering ribs.

When heating the fuel cell stack, the initial cell and the end cell of the fuel cell stack would generally require a slightly higher heat flux to achieve the same temperature as in the middle of the fuel cell stack, since the components required for bracing, located in the area of the initial cell and the end cell, such as aluminum end plates, have a high heat capacity, which has an influence on the temperature of the outer cells of the fuel cell stack through heat conduction when the cell stack is heated.

In the operation of the fuel cell stack at equilibrium operating temperature, on the other hand, the outer cells (for example, the initial cell and the final cell) would have to be cooled somewhat less (lower flowing heat flux to the cooling air) than cells in the center of the fuel cell stack, since the transfer of heat (for example, by convection or radiation) from the components necessary for bracing, such as aluminum end plates, to the air, affects the temperature of the outer cells of the fuel cell stack.

To reduce this influence, the end plates can be provided with insulating plates facing the cells and/or with insulating material facing the surrounding air.

These influences (boundary effects) on the outer cells may be different in absolute value when cooling during operation than when heating during startup.

In order to take account of these boundary effects, which would have to be compensated for by a different air flow during cooling on the one hand and heating on the other, if necessary, in order to achieve a uniform temperature distribution, appropriate devices such as bimetallic, shape memory alloy or electrically controlled flaps, baffles, guide elements or pushers can also be provided, which allow a different flow to the tempering elements during heating than during fuel cell operation.

The supply of hot air during heating and cooling air during cooling of the cell stack can be done by the same blower (or fan) (e.g. heating device between blower and cell stack). In an alternative embodiment, one or more separate blowers are used to supply the hot air and likewise one or more separate blowers are used to supply the cooling air. In a further embodiment, the hot air from one or more separate blowers and the cooling air from one or more separate blowers can be at least partially mixed before reaching the tempering ribs.

If hot air is supplied during heating and cooling air is supplied during cooling of the cell stack via the same blower (or fan) without additional controlled elements, the problem arises that with optimum temperature distribution during fuel cell stack operation, on the other hand, a poor temperature distribution prevails during heating of the fuel cell stack, resulting in a longer heating time until the minimum temperature of the cells for starting operation is reached (negative for fuel cell system starting time). The reason for this is that when cooling the fuel cell stack, there is a different cooling requirement for the various areas of the cell stack than there is a heat requirement when heating the cell stack (e.g. during heating, there is a particularly high heat requirement at the edge cells).

The advantage of using separate blowers to supply hot air to the cell stack is that during heating of the cell stack, the edge cells (e.g. first and last cell) require more heating power and thus more hot air volume flow and/or temperature than middle areas of the cell stack (due to high heat capacity of the end plates of the cell stack and/or high heat dissipation at the end plates e.g. due to insufficient insulation), whereas the edge cells during fuel cell operation usually require less heat dissipation than middle areas of the cell stack. due to insufficient insulation), whereas the edge cells usually require less heat dissipation than central areas of the cell stack during cooling during fuel cell operation, and thus the areas of the cell stack that require more heat (e.g. edge cells) can be heated more strongly (e.g. higher temperature and/or higher hot air volume flow) during the heating phase via separate blowers for the supply of hot air. Another advantage of the separated design of blowers for heating and blowers for cooling the cell stack can be that the cooling air volume flow necessary for fuel cell operation does not have to flow through the heating device, which can result in a lower pressure drop and thus a lower power requirement of the one or more blowers active during fuel cell operation.

In one embodiment, it can be provided that other tempering air guiding elements, resistor elements, perforated plates or guide plates are primarily supplied with air for heating the cell stack than for cooling the cell stack. One or more fans can flow to certain tempering air guiding elements (for example plates with larger recesses in the area of the edge cells of the cell stack) for heating the cell stack and one or more fans can flow to other tempering air guiding elements (for example plates with smaller or equally large recesses in the area of the edge cells of the cell stack) for cooling the cell stack. It is also possible for the air to flow successively through the tempering air guiding elements, which are each intended for heating or cooling. For example, the air for heating the cell stack can first flow through the tempering air guiding element, which primarily serves to distribute the hot air, and then flow through the tempering air guiding element, which primarily serves to distribute the cooling air. For example, the tempering air guiding element with the later flow can have recesses with a larger overall cross section than the tempering air guiding element with the earlier flow in order to influence the flow distribution at the tempering air guiding element with the earlier flow as little as possible. Instead of the tempering air guiding element with the later flow, the resistor elements on the tempering ribs can also fulfill this function.

Provided that the same blower (or fan) is used to supply both hot air when heating and cooling air when cooling the cell stack (e.g. to minimize the number of blowers), the different volume flow supply to certain areas of the cell stack can also be realized by one or more con-trolled/regulated air guiding elements such as flaps, valves or sliders (e.g. two perforated plates provided with different sized holes movable on top of each other).

If one or more blowers are connected to the tempering device and hot air is present inside the tempering device (for example, when heating the cell stack with hot air or due to waste heat from the cell stack), a flow of hot air into a blower can damage it. To prevent the flow of hot air into one or more blowers, one or more blowers or fans may be preceded or followed by non-return dampers or corresponding devices that prevent hot air from flowing into the blower or fan. Alternatively or supportively, the blower or fan in question can be operated at a certain speed (formation of back pressure and/or light cooling air volume flow) to prevent hot air from flowing into the blower. This can be monitored by a temperature sensor (e.g. thermocouple), which is for example connected downstream of the fan, so that the maximum permissible temperature at the fan is never exceeded and thus damage to the fan is avoided. In particular, when hot air and cooling air are supplied separately to the tempering device by separate blowers, one of the measures described must prevent the hot air from flowing into the blower which is used to supply cooling air to the tempering device.

In the course of the flow of air in the tempering direction from a first cell of the fuel cell stack to a last cell of the fuel cell stack, the air flowing in the tempering direction in the tempering channel can already warm up somewhat (for example by five degrees Celsius) during operation of the fuel cell stack due to heat transfer from the tempering elements to the air flowing past.

In fuel cell operation at equilibrium, it is therefore possible that warmer cooling air arrives at the tempering element near the last cell than at the tempering element near the first cell.

Accordingly, during heating it is possible that colder heating air arrives at the tempering element near the last cell (due to heat transfer from the air in the tempering channel to several tempering elements) than at the tempering element near the first cell.

This can be taken into account and/or compensated for, for example, by appropriate air guidance (i.e. by distributing the volume flow/mass flow) or by the design of the tempering elements, tempering bodies and/or resistor elements.

If the cooling air or heating air (tempering air) originates from a blower unit or a heating unit, the design of the duct within the blower unit or the heating unit can have a significant influence on the air distribution on the fuel cell stack. This may be the case, for example, if the air flow at the outlet from the blower device or heater device is not directed exactly in the tempering direction of the fuel cell stack. Furthermore, the velocity distribution of the gas particles within the duct or the flow form (turbulent, laminar) can play a role. The flow guidance within the blower device or heater device or, for example, flow breakers or deflectors can also have an influence on the air distribution to the cells of the fuel cell stack or cell stack.

To ensure good dissipation of the heat generated, it is possible for heat sinks to be attached to the stack or fuel cell stack on one or more side surfaces to increase the exchange area. These heat sinks can, for example, be prefabricated heat exchangers or cooling profiles/cooling elements. In this variant, the tempering elements can, for example, be flush with one or more side surfaces of the fuel cell stack, with one or more large-area aluminum heat sinks making thermal contact with the fuel cell stack. The fins of the aluminum heat sink can serve as tempering ribs.

The heat sinks can be thermally bonded to the stack or fuel cell stack with heat conducting foil. Curved aluminum sheets tapering at an acute angle can serve as air ducts, for example.

The heat-conducting foil and/or anodizing of the aluminum can be used here, among other things, for electrical insulation in order to prevent a short circuit across several cells if necessary.

Ducts and/or pipes for conducting one or more fluids (for example for heat transfer from or to this fluid) can be provided in the heat exchanger or heat sink. Lines carrying a fluid can contact or be thermally connected to the means for influencing the tempering air flow of a fuel cell stack.

Various types of fuel cells and their respective operating temperatures (OT), which can be heated and cooled (or temperature-controlled) in conjunction with the tempering device according to the invention, are listed below as examples.
Alkaline fuel cell (AFC); OT: 60° C. to 100° C.;
Polymer electrolyte membrane fuel cell (PEMFC); OT: Low temperature PEMFC: 60° C.-110° C.; High temperature PEMFC: 120° C.-190° C. or up to approx. 230° C.;
Direct methanol fuel cell (DMFC); OT: 30° C. to 130° C.;
Phosphoric acid fuel cell (PAFC); OT: 170° C. to 230° C.;
Molten carbonate fuel cell (MCFC); OT: Approx. 650° C.;
Solid acid fuel cell; OT: 200° C. to 300° C.
Solid oxide fuel cell (SOFC); OT: 650° C. to 1000° C.;

The tempering device may have one or more tempering air inlets and one or more tempering air outlets per side wall of the fuel cell stack.

The tempering air inlet(s) are provided for supplying tempering air to the tempering air guide and in particular to the tempering channel. The tempering air outlet(s) is (are) provided for discharging the tempering air.

The tempering air inlet(s) and the tempering air outlet(s) can also be formed by appropriately designed tempering elements.

The technical features of the embodiments of the present invention can be combined with each other in any way, provided that it is technically feasible to do so.

### LIST OF REFERENCE SIGNS

1 Tempering device
2 Fuel cell stack
3 Anode inlet
4 Anode outlet
Cathode inlet
6 Cathode outlet
7 Reformer device
8 Repeating unit
9 Tempering element
Tempering rib
11 Heat conduction element
12 Tempering air guide
13 Cutout
14 Side wall
15, 15.1, 15.2 Tempering channel
16 Tempering direction
17 Supply plate
18 Resistor element (spacer)
19 Tempering body
Tempering air guiding element
21 Recess
22 Main tempering channel
23 Tempering air supply
24 Through hole
Recess

1. Tempering device for tempering of a stacked energy storage device or energy converter formed by a plurality of cells, comprising
a plurality of plate-shaped heat conduction elements arranged between the cells of the energy storage device or energy converter, wherein the tempering of the cells is effected via the plate-shaped heat conduction elements by means of heat conduction,
a plurality of tempering ribs arranged outside the cells for changing a flow direction of a tempering air stream, the tempering ribs being thermally coupled to the heat conduction elements, and the tempering of the plate-shaped tempering ribs being effected by exposure to a tempering air stream by means of convection and/or via structural means by means of heat conduction.

2. The tempering device according to claim 1, wherein
the means for influencing the tempering air flow and/or for guiding the tempering air are provided, which means are designed to change a flow direction and/or a flow velocity of the tempering air flow, the means being structurally designed and/or arranged in such a way that several of the tempering ribs can be acted upon by a tempering air volume flow in such a way that a majority of the cells in a cell center can be heated or cooled approximately uniformly, and wherein the means for influencing the tempering air flow and/or for guiding the tempering air comprise one and preferably two or more of the following components
at least one further tempering rib, the shape and/or arrangement of which differs from the shape and/or arrangement of the other tempering ribs, and/or
at least one resistor element to change the tempering air flow by local distribution of pressure drops and/or by vortex formation, and/or
at least one tempering air guiding element for further changing the flow direction and/or the flow velocity of the tempering air flow compared to changing the flow direction and/or the flow velocity of the tempering air flow by the tempering ribs and/or
at least one tempering body, which is designed as a heat exchanger.

3. The tempering device according to claim 1, wherein
the plurality of tempering ribs assigned to a side wall of the device have, at least in part, surfaces of different size and/or surfaces of at least in part the same size and/or in that the tempering ribs have cutouts of different size and/or the same size, the cutouts being provided for passing through and influencing the tempering air flow, and the size of the outcuts increasing or decreasing in the tempering direction and/or in that the tempering ribs delimit and/or form one or more tempering air channels at least in regions.

4. The tempering device according to claim 1, wherein
the resistor elements are arranged in the region of two adjacent tempering ribs and approximately orthogonally to the tempering ribs, the resistor elements being approximately plate-shaped and preferably having one or more openings or recesses.

5. The tempering device according to claim 1, wherein
the tempering air guiding element(s) have recesses which form a tempering air channel tapering in the tempering direction.

6. The tempering device according to claim 1, wherein
the tempering body or bodies are designed as a heat exchanger device, the heat exchanger device having ribs and/or the ribs of the heat exchanger device being at least partially the tempering ribs.

7. The tempering device according to claim 1, wherein
one or more of the means for influencing the tempering air flow form a tempering channel tapering in the tempering direction.

8. The tempering device according to claim 1, wherein,
the tempering ribs are integrally formed on the heat conduction elements.

9. The tempering device according to claim 1, wherein
the heat conduction elements have a thickness of greater than 0.9 mm and preferably greater than 1.4 mm.

10. The tempering device according to claim 1, wherein
at least one tempering air supply means is provided for supplying one or more of the means with a tempering air flow in a tempering direction from an initial cell of the cell stack to an end cell, and/or
at least one tempering air discharge for discharging the tempering air from the tempering device, the tempering air supply and the tempering air discharge being part of the tempering air guide.

11. The tempering device according to claim 1, wherein
the tempering ribs and/or the tempering air guiding elements are structurally designed in such a way that the flow resistance of the tempering air guide increases in the tempering direction, and/or
that all cells can be supplied with approximately the same volume flow (or mass flow) of tempering air, and/or
in that the tempering air guiding elements and/or the tempering ribs delimit in sections at least one tempering channel which extends essentially in the tempering direction and whose cross section decreases in the tempering direction, and/or
that a cross-section of the tempering air guide tapers in the tempering direction, and/or in that the spacer elements are arranged between the tempering air guiding elements and/or the tempering ribs and approximately orthogonally thereto, so that heat transfer surfaces of the tempering ribs and/or the tempering bodies and/or the tempering air guiding means become larger in the tempering direction, and/or
in that the resistor elements are arranged between the tempering air guiding elements and/or the tempering ribs, so that a higher heat transfer from or to the tempering air guiding elements and/or tempering ribs takes place as a result of the flow of tempering air onto the tempering air guiding elements and/or tempering ribs, and/or in that the tempering bodies are arranged on the tempering air guiding elements and/or
the tempering ribs, so that a better heat transfer from and to the tempering ribs takes place due to a higher heat transfer surface.

12. The tempering device according to claim 10, wherein
cross-sections and/or number of one or more tempering air supply lines and/or of one or more tempering air discharge lines are matched to one another in such a way that the tempering of a cell stack is approximately uniform, and/or
in that the flow of the tempering air to the tempering ribs is automatically regulated and/or controlled on the basis of operating parameters of the cell stack.

13. The tempering device according to claim 1, wherein
the tempering channel is bounded in sections transverse to the tempering direction by the tempering air guiding elements and/or by the tempering ribs, a side wall of a cell stack and a housing surrounding the cell stack.

14. The tempering device according to claim 1, wherein
the plate-shaped heat conduction elements form sealing elements of the cell stack.

15. Fuel cell stack comprising several fuel cells connected in series, forming the approximately cuboidal fuel cell stack, wherein
at least one side wall or preferably two, in particular mutually opposite, or three or four side walls are provided with a tempering device in accordance with claim 1, the tempering device having one or more tempering air inlets and one or more tempering air outlets per side wall of the fuel cell stack and at least one plate-shaped tempering air guiding element or resistor element being formed for distributing the hot air flow so that the edge cells of the cell stack are subjected to a stronger flow during heating than the majority of the remaining cells, and/or in that at least one plate-shaped tempering air guiding element or resistor element serves to distribute the cooling air flow.
